(19) United States
(12) Patent Application Publication
(10) Pub. No.: US 2011/0291817 A1
(43) Pub. Date: Dec. 1, 2011

(54) AV Equipment Control Device

(75) Inventors: Hirochika MAEGAKI, Hamamatsu-shi (JP); Katsuaki Tanaka, Hamamatsu-shi (JP); Yuki Yoshizawa, Hamamatsu-shi (JP)

(73) Assignee: Yamaha Corporation, Hamamatsu-shi (JP)

(21) Appl. No.: 12/787,846

(22) Filed: May 26, 2010

(30) Foreign Application Priority Data
May 26, 2010 (JP) 2009-127075

(51) Int. Cl. G05B 11/01

(52) U.S. Cl. 340/12.22; 340/4.37; 348/734

(57) ABSTRACT

An AV equipment control device includes a detecting portion that detects a state of a signal line which is connected to a controlled object equipment to transmit an audio signal or a video signal, a control signal generating portion that generates a control signal to control the controlled object equipment, a deciding portion that decides a state of the controlled object equipment based on a detected content of the detecting portion, and a controlling portion that controls the control signal generating portion based on a decision result of the deciding portion.

### BACKGROUND

The present invention relates to an AV equipment control device for controlling an external equipment connected via an audio/video transmitting line.

The custom installation used to construct the AV system by combining a plurality of AV (audio/video) equipments freely is widely adopted. In the custom installation, the AV receiver is employed in the situation that reproduction of audio/video contents should be centrally controlled in the whole house (Non-Patent Literature 1, for example).

The AV receiver performs the function that connects a plurality of source equipments, e.g., STB (Set-Top Box), DVD player, BD player, VCR (Video Cassette Recorder) deck, and the like and a television receiver (monitor), and controls the source equipment and the television receiver in response to the user's operation.

[Non-Patent Literature 1] Yamaha Corporation of America, “RX-V/RX-Z/JRX-N Series, AV Receivers from Yamaha Electronics”, [online], 2009, Yamaha Corporation of America, [May 15, 2009 searched], Internet <URL:http://www.yamaha.com/yec/products/productdetail.html?CNTID=558249&CTID=5000300>

When controlling the source equipment and the television receiver, the AV receiver is required to determine a condition of a controlled subject equipment and transmit a control command (a remote control code, or the like) in response to that condition. However, such a situation is not common that the AV equipment informs other equipments of its own condition. Therefore, it is difficult for the AV receiver to grasp respective conditions of the controlled subject equipments.

The HDMI (High-Definition Multimedia Interface) standard is defined as the interface that connects the AV equipments, and the CEC (Consumer Electronics Control) standard is employed in this standard to control the equipments mutually. However, the control commands used in respective companies are not standardized. As a result, in the custom installation in which the equipments of a plurality of manufacturers are combined freely, it is impossible to implement the mutual control based on the control commands.

### SUMMARY

Therefore, it is an object of the present invention to provide an AV equipment control device capable of controlling appropriately a controlled subject equipment in the system in which the information indicating its own condition is not transmitted from the controlled subject equipment.

In order to achieve the above object, according to the present invention, there is provided an AV equipment control device, comprising:

a detecting portion that detects a state of a signal line which is connected to a controlled object equipment to transmit an audio signal or a video signal;

a control signal generating portion that generates a control signal to control the controlled object equipment;

a deciding portion that decides a state of the controlled object equipment based on a detected content of the detecting portion; and a controlling portion that controls the control signal generating portion based on a decision result of the deciding portion.

Here, the transmission of the audio signal/video signal may contain the real-time signal transmission or the packet streaming.

According to the present invention, there is also provided an AV equipment control device, comprising:

a HDMI interface connected to a controlled object equipment;

a control signal generating portion that generates a control signal to control the controlled object equipment;

a deciding portion that decides an ON/OFF state of a power supply of the controlled object equipment, based on voltages of a hot plug detection pin and a TMDS pin of the HDMI interface; and

a controlling portion that decides whether or not to control the control signal generating portion to generate a control signal which reverses the ON/OFF state of the power supply of the controlled object equipment, based on a decision result of the deciding portion.

According to the present invention, the condition of the controlled subject equipment can be decided based on the state of the signal line of the audio signal or the video signal, which is indispensable to the AV system, and the controlled subject equipment can be controlled based on the decision result. As a result, even when the AV system is constructed by combining the AV equipments of a plurality of manufacturers, the adequate control between the equipments can be applied.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a configurative view of an AV system including an AV receiver according to an embodiment of the present invention;

FIG. 2 is a block diagram of the AV receiver;

FIG. 3 is a view explaining remote control signals stored in an IR controller;

FIGS. 4A and 4B are views showing a profile and a pin arrangement of a HDMI connector; and

FIGS. 5A and 5B are flowcharts showing an operation of the AV receiver.

### DETAILED DESCRIPTION OF EXEMPLARY EMBODIMENTS

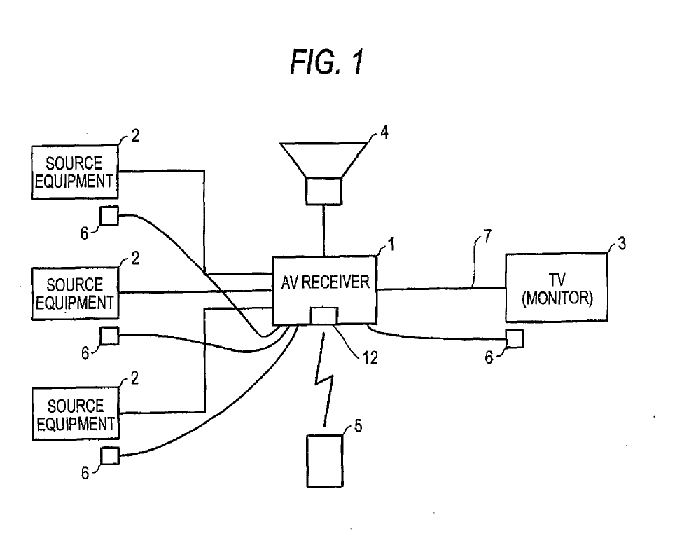

FIG. 1 is a configurative view of an AV system including an AV receiver 1 according to an embodiment of the present invention. This AV system corresponds to the so-called custom installation system that is constructed by connecting a plurality of source equipments 2, a TV (monitor) 3, and a speaker 4 to the AV receiver 1.

The AV receiver 1 has a selector capability for selecting one equipment from a plurality of source equipments 2, an audio amplifier capability for amplifying sound signals being input from the source equipment 2 and outputting the amplified signals to the speaker, a repeater capability for outputting video signals being input from the source equipment 2 to the TV 3 on the downstream side, a tuner capability for receiving a radio broadcast such as FM broadcast, a commander capability for controlling the source equipment 2 and the TV 3 in response to the user's operation, and the like. The user can control all equipments via the AV receiver 1 by transmitting the command to the AV receiver 1 from a remote controller 5.

As the source equipment 2 connected as the upstream-side equipment of the AV receiver 1, there are STB (Set-Top Box), DVD player, BD player, VCR (Video Cassette Recorder) deck, and the like, for example. Also, the TV 3 connected as the downstream-side equipment of the AV receiver 1 is used mainly as a monitor that displays the video image being input from the AV receiver 1.

The AV receiver 1 and the TV 3 are connected via a HDMI cable 7. Also, the AV receiver 1 and the source equipment 2 are connected via the HDMI cable or an analog cable.

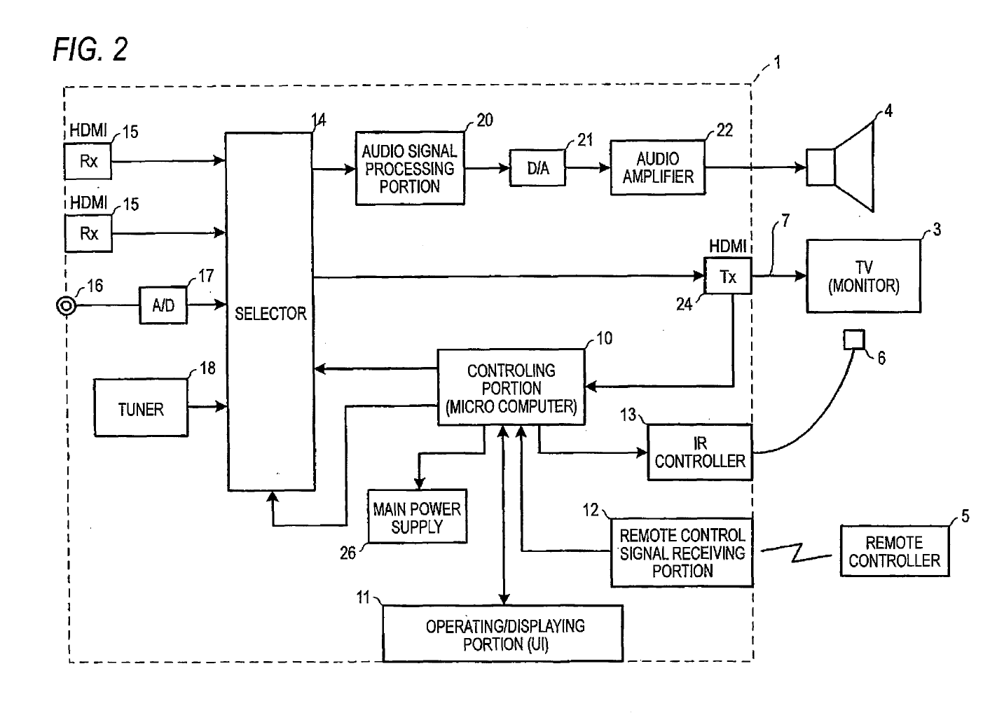

The AV receiver 1 has a remote control signal receiving portion 12 that receives an infrared remote control signal being generated by the remote controller 5. Also, an IR flasher 6 is provided to the infrared light receiving portions of the source equipments 2 and the TV 3 respectively. The IR flasher 6 is connected to the AV receiver 1. The IR flasher 6 generates a light under control of the AV receiver 1 (IR controller 13: see FIG. 2), and outputs the remote control signal to control the source equipments 2 and the TV 3.

FIG. 2 is a block diagram of the AV receiver 1. HDMI receivers 15, an ND converter 17, a tuner 18, and a controlling portion 10 are connected on the source side of a selector 14. Digital source equipments such as STB, DVD player, etc. are connected to the HDMI receivers 15. An analog jack 16 is connected to the ND converter 17, and an analog source equipment such as the VCR deck, or the like is connected to the analog jack. Also, the tuner 18 is the equipment that receives/reproduces the broadcast sound such as the FM broadcast, or the like, and is built in the AV receiver 1. The controlling portion 10 is constructed by a microcomputer, or the like, and has a function to switch the selector 14. Also, the controlling portion 10 is connected to the source side to display OSD (On-Screen Display) such as various operation guides, set wizards, etc., background video, and the like.

The controlling portion 10 switches the sources of the selector 14 in response to a switching operation, and the like being input from the remote controller 5 or an operating/displaying portion 11.

The video signal containing the audio signal, only the audio signal, or the video signal containing the video image only is input into the selector 14. The selector 14 outputs the audio signal of the selected equipment to an audio signal processing portion 20, and outputs the video signal of the selected equipment to a HDMI transmitter 24. The TV 3 is connected to the HDMI transmitter 24 via the HDMI cable 7.

A tone quality, and the like of the audio signal is adjusted by the audio signal processing portion 20, and then the adjusted audio signal is converted into an analog signal by a D/A converter 21. This audio signal is amplified by an audio amplifier 22, and is input into the speaker 4. In this case, when the audio amplifier 22 is composed of the digital amplifier, the D/A converter 21 is composed of the circuit that converts the audio signal from the PCM code to the PWM signal.

The remote controller 5 has a power ON/OFF button of the AV receiver 1, and a button for selecting the source equipment 2. When the button is operated by the user, the remote controller 5 generates the infrared remote control signal responding to the operated button. The AV receiver 1 has the remote control signal receiving portion 12 that receives the infrared signal generated by the remote controller 5. When the remote control signal receiving portion 12 receives the remote control signal generated by the remote controller 5, the remote control signal receiving portion 12 analyzes the command code of the remote control signal and inputs the code to the controlling portion 10. The controlling portion 10 executes a process corresponding to the command, based on the command code being input from the remote control signal receiving portion 12.

When the received command corresponds to the command directed to the AV receiver 1, the AV receiver 1 carries out the corresponding process by the corresponding function portion of its own receiver. For example, when the AV receiver 1 receives the command to increase/decrease a volume of reproduced sound, the controlling portion 10 controls the audio amplifier 22 to increase/decrease a volume of sound. Also, when the AV receiver 1 receives the command to turn ON a power supply of the system, the controlling portion 10 controls to turn ON a main power supply 26 of its own receiver and also turn ON power supplies of the TV 3 and the source equipment 2.

When the controlling portion 10 controls the external equipment such as the TV 3, the source equipment, or the like, the controlling portion 10 issues the command to the IR controller 13 to cause the IR controller 13 to output the corresponding remote control signal.

In FIG. 2, only the IR controller 13 and the IR flasher 6 are illustrated for the purpose of controlling the TV 3. In this case, similarly an IR controller and an IR flasher are provided respectively to control source equipments 2.

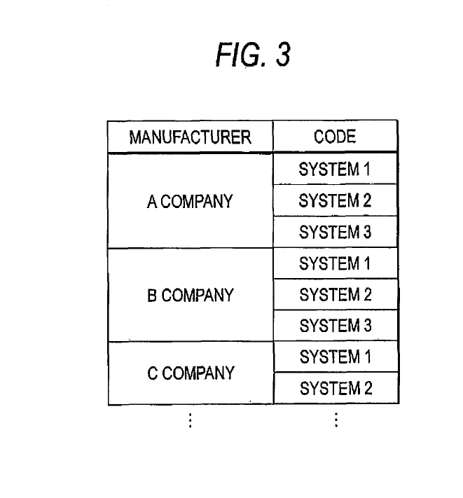

Here, as shown in FIG. 3, the IR controller 13 has a table in which plural remote control code systems of plural manufactures are stored respectively. That is, the used remote control code systems of the source equipments such as STB, and the like, and the TV 3 are different according to individual models and manufactures. The IR controller 13 stores all remote control code systems corresponding to respective models of respective manufactures such that this controller can produce the remote control signal to correspond to all models of all manufactures. Also, when the AV system in FIG. 1 is installed, it is registered in the controlling portion 10 of the AV receiver 1 that what equipments of which manufactures are connected as the TV 3 and the source equipments 2.

In controlling the controlled subject equipments (the TV 3, the source equipments 2), the controlling portion 10 issues the command having a name of the manufacturer, the code system, and the control contents to the IR controller 13. The IR controller 13 outputs the remote control code, which contains the designated control contents in the designated code system of the designated manufacturer, based on the command, and then causes the IR flasher 6 to emit the light in response to the remote control code. The infrared remote control signal being output by the flashing of the IR flasher 6 is received by an infrared-light receiving portion of the controlled subject equipment, and then is input into a controlling portion of the controlled subject equipment.

Here, there are a discrete (fixed) code and a toggle (reverse) code as the remote control code. For example, in the case of a power control code, a power ON code and a power OFF code correspond to the discrete code, and a power reverse code corresponds to the toggle code. In the case of the discrete code, when the discrete code is transmitted even in such a situation that the condition of the controlled subject equipment is unknown, the controlled subject equipment is set to the state that is instructed by the discrete code. For example, when the power ON code is transmitted to the equipment whose power is turned OFF, the power of the equipment is turned ON. In contrast, even when the power ON code is transmitted to the equipment whose power has already been turned ON, the power ON state is still kept and is not changed. In this manner, the user can transmit the discrete code even though such user is unaware of the condition of the controlled subject equipment.

On the other hand, in the case of the toggle code, the user must decide whether the transmission of the code should be made or not and the number of times of transmission should be made, after the user decides the condition of the controlled subject equipment. For example, in the case of the power reverse code, when the power reverse code is transmitted to the equipment whose power has already been turned OFF, the power of the equipment is turned ON (the power is reversed from OFF to ON). In contrast, when the power reverse code is transmitted to the equipment whose power has already been turned ON, the power of the equipment is turned OFF (the power is reversed from ON to OFF). In this manner, when the user wishes to turn ON the power of the controlled subject equipment, such user cannot decide whether or not the power reverse code should be transmitted even after such user checks that the power of the controlled subject equipment has already been turned OFF.

Here, the use of the toggle code has the merit that the number of codes can be decreased. For example, in the case of power ON/OFF, two types of codes, i.e., the power ON code and the power OFF code, are needed when the discrete code is used whereas only a single code, i.e., the power reverse code, is needed when the toggle code is used. Also, in the case of channel switching, plural codes corresponding to the number of channels are needed when the discrete code is used. In contrast, merely either one channel ascending code is needed or two codes, i.e., the channel ascending code and the channel descending code are needed when the toggle code is used. Therefore, some of code systems have no discrete command for a part or all of control contents.

For this reason, when the code system of the controlled subject equipment has only the toggle code for the requested control contents, the controlling portion 10 of the AV receiver 1 decides the condition of the controlled subject equipment, and then decides whether or not the toggle code is transmitted or the number of times of transmission is made. Concretely, in this embodiment, when the TV 3 only accepts the power reverse code with respect to the power ON request of the TV 3, the controlling portion 10 decides the power ON/OFF of the TV 3 based on the pin (signal line) voltage of the HDMI connector that the HDMI transmitter 24 detects, and then decides whether or not the power reverse code should be transmitted.

In this embodiment, when both the HPD (Hot Plug Detection) pin and the TMDS (Transition Minimized Deferential Signaling) pin are at the High level, it is decided that the power of the TV 3 has been turned ON.

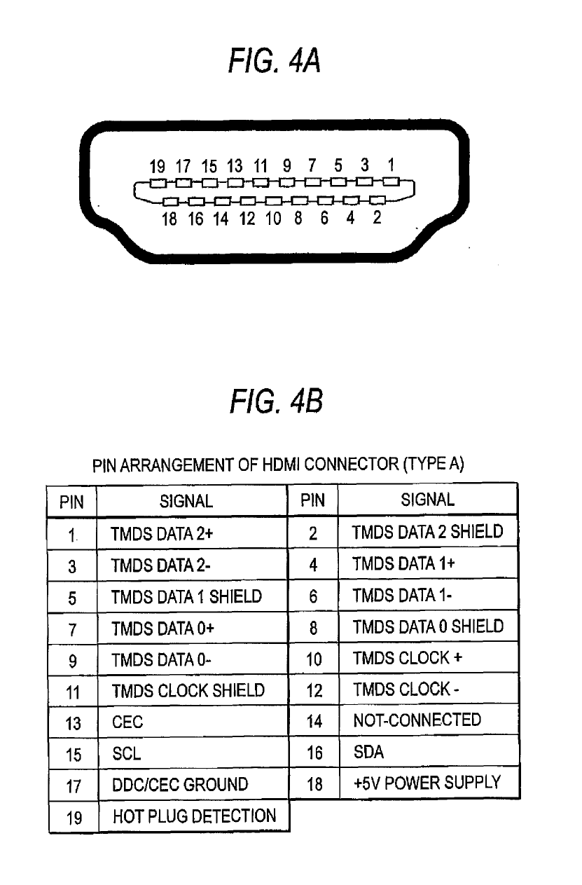

FIGS. 4A and 4B are views showing a connector structure and a pin arrangement of the HDMI connector. The HDMI connector used commonly is the 19-pin type that is called the type A. The 19-th pin of these pins corresponds to the HPD (Hot Plug Detection) pin. The hot plug detection pin indicates that the downstream-side (sink) equipment is brought into its power-ON state against the inquiry from the upstream-side (source) equipment, for example the AV receiver 1, concretely, that the EDID (Extended Display Identification Data: inter-equipment authentication data) of the sink equipment can be read by the source equipment. Some of the sink equipments are of the type that loops back the 5 V power fed from the source equipment via the 18-th pin as it is. In the case of such equipment, the HPD pin is still kept at the High level even after the power is turned OFF.

Also, the 1-st, 3-rd, 4-th, 6-th, 7-th, and 9-th pins of the HDMI connector are the TMDS pins, and are used to transmit the digital video signal. The sink equipment terminates these pins to 3.3 V, 50 Ω when such equipment can be set up to receive the video signal, and thus this voltage also appears on the pins on the source side.

The controlling portion 10 detects the voltages at the HPD pin (19-th pin) and the TMDS pin (any one of the 1-st, 3-rd, 4-th, 6-th, 7-th, and 9-th pins). Then, when both pins are at the High level, the controlling portion 10 decides that the power of the TV 3 has already been turned ON. The controlling portion 10 decides whether or not the power reverse code should be transmitted to the TV 3, based on the detected situation.

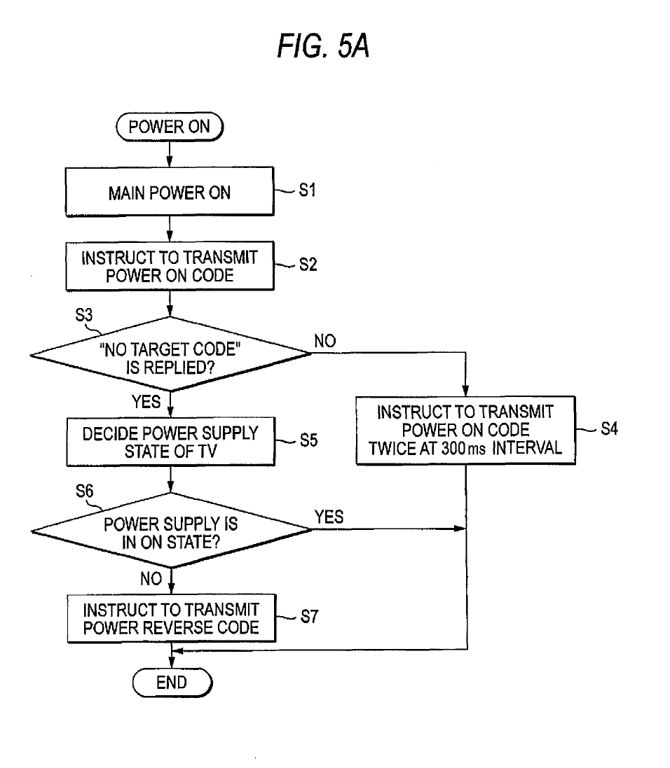

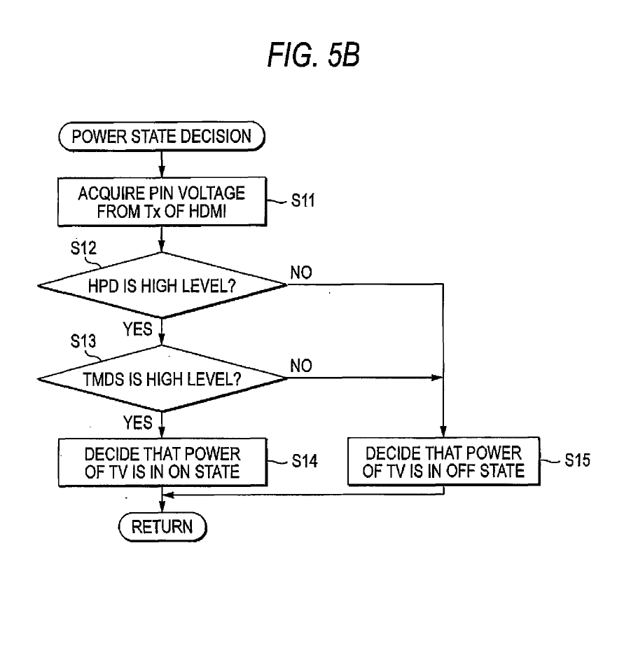

FIG. 5A is a flowchart showing an operation of the controlling portion 10 upon turning ON the power. This flowchart shows the operation taken when a power ON signal of the system is input from the remote controller 5. When the controlling portion 10 receives the power ON signal, the controlling portion 10 turns ON the main power supply 26 of its own AV receiver (S1). Then, the controlling portion 10 instructs the IR controller 13 to transmit the power ON code as the discrete code to the TV 3 as the downstream equipment (S2). This instruction is executed to issue the command that has the manufacturer code of the TV 3, the code series number, and the control contents (power ON). The IR controller 13 executes the operation in accordance with this command. Here, when the target code (discrete code) is not present in the instructed code system, the IR controller 13 sends back a message indicating that the target code is not present (no target code) to the controlling portion 10. Then, the controlling portion 10 decides whether or not “no target code” is replied from the IR controller 13 (S3).

Then, the controlling portion 10 waits for the reply for a predetermined time. If the reply indicating that “no power ON code” is not sent back from the IR controller 13 (NO in S3), the controlling portion 10 decides that the power ON code as the discrete code is present in the instructed code system and also the IR controller 13 transmits this code normally. Then, the process goes to S4. In S4, the controlling portion 10 further transmits the power ON code twice at a predetermined interval (300 ms). In other words, even though the power ON code is transmitted plural times, the controlled subject equipment is not changed into the states other than the power ON state, and therefore the controlling portion 10 transmits the power ON code plural times to increase the certainty of control.

In contrast, if the reply indicating that “no power ON code” is sent back from the IR controller 13 (YES in S3), the controlling portion 10 decides a current power state of the TV 3 (S5). This power state deciding process will be explained with reference to a flowchart in FIG. 5B hereunder.

In FIG. 5B, the controlling portion 10 acquires states of the HPD pins and the TMDS pins from the HDMI transmitter 24 that is connected to the TV 3 (S11). Then, the controlling portion 10 decides whether or not both the HPD pin and the TMDS pin are at the High level (S12, S13). If it is decided in either of both steps that the pins are not at the High level, the controlling portion 10 decides that the power of the TV 3 is in its OFF state (S15). In contrast, if it is decided in both steps that the pins are at the High level, the controlling portion 10 decides that the power of the TV 3 is now in its ON state (S14). The process goes back to the main routine in answer to these decision results.

That is, in the main routine in FIG. 5A, the controlling portion 10 decides whether or not the power has already been turned ON (S6). If it is decided that the power of the TV 3 has already been turned ON (YES in S6), the controlling portion 10 terminates the process as it is. In contrast, if it is decided that the power of the TV 3 is in its OFF state (NO in S6), the controlling portion 10 transmits the power reverse code as the toggle code (S7). Then, the controlling portion 10 terminates the process.

As described above, the condition of the controlled subject equipment can be decided based on the state of the signal line of the video signal, and then it can be decided whether or not the toggle code should be transmitted, based on the decision result. As a result, the controlled subject equipment can be controlled correctly even when the discrete code is not present.

Also, when the power of the TV 3 is turned ON in a condition that the power of the AV receiver 1 has already been turned ON, the processing action may be started from S2.

In this case, in order to increase the certainty of control applied to the controlled subject equipment, the process may be caused to stand by for a time that is enough for the TV 3 to turn ON the power after the power reverse code is transmitted in S7, and then the operations subsequent to S5 may be executed once again.

Also, when the power of the TV 3 is to be turned OFF, the processes opposite to those in FIGS. 5A and 5B may be executed. That is, it may be decides that the power of the TV 3 has already been turned ON, and then the power reverse code may be transmitted only when the power is now in its ON state. Here, in such a situation may be considered that the TV 3 is always turned ON while the power of the AV receiver 1 is turned ON, the transmission of the power reverse code (the process in S7) may be executed without the decisions (the processes in S5, S6 in FIG. 5A).

In this embodiment, the AV receiver 1 is employed as the AV equipment control device. But the concrete configuration of the AV equipment control device is not limited to the AV receiver. Also, the control signal that the control signal generating portion generates is not limited to the infrared remote control signal.

In this embodiment, the power ON/OFF state of the sink equipment (the TV 3) is decided based on the states of the HPD pins and the TMDS pins of the HDMI interface, and then it is decided based on this decision result whether or not the power reverse code should be transmitted to the sink equipment. But the present invention is not limited to this embodiment. That is, the interface is not limited to the HDM1 interface, and the interface constructed based on other standard may be employed if the interface can transmit the contents stream such as the video, the audio, and the like. Also, the sink equipment is not limited to the TV 3. A projector may be employed as the sink equipment. Also, the control contents are not limited to the power ON/OFF. A vide signal may be employed as the control contents. Also, the controlled object equipment is not limited to the sink equipment. The source equipment may be selected as the controlled object equipment.

The present application is based on Japanese Patent Application No. 2009-127075 filed on May 26, 2009, the contents of which are incorporated herein by reference.

What is claimed is:

1. An AV equipment control device, comprising:
a detecting portion that detects a state of a signal line which is connected to a controlled object equipment to transmit an audio signal or a video signal;
a control signal generating portion that generates a control signal to control the controlled object equipment;
a deciding portion that decides a state of the controlled object equipment based on a detected content of the detecting portion; and
a controlling portion that controls the control signal generating portion based on a decision result of the deciding portion.

2. An AV equipment control device, comprising:
a HDMI interface connected to a controlled object equipment;
a control signal generating portion that generates a control signal to control the controlled object equipment;
a deciding portion that decides an ON/OFF state of a power supply of the controlled object equipment, based on voltages of a hot plug detection pin and a TMDS pin of the HDMI interface; and
a controlling portion that decides whether or not to control the control signal generating portion to generate a control signal which reverses the ON/OFF state of the power supply of the controlled object equipment, based on a decision result of the deciding portion.
